(19) United States
(12) Patent Application Publication
(10) Pub. No.: US 2008/0006181 A1
(43) Pub. Date: Jan. 10, 2008

(54) Method of using household waste in the production of concrete

(76) Inventor: John Gerard Cronin, County Cork (IE)

Correspondence Address: JACOBSON HOLMAN PLLC, 400 SEVENTH STREET N.W., SUITE 600, WASHINGTON, DC, 20004, US

(21) Appl. No.: 11/654,697

(22) Filed: Jan. 18, 2007

Related U.S. Application Data
(63) Continuation of application No. 10/532,600, filed on Dec. 7, 2005, now abandoned.

(30) Foreign Application Priority Data
Oct. 24, 2002 (IE) S2002/0832

(51) Int. Cl. C04B 18/18

(52) U.S. Cl. 106/697

(57) ABSTRACT

There is shown a method of treating household waste comprising separation, shredding and dewatering steps, as well as detoxifying steps, prior to mixing the household waste with an alkali solution and thereafter mixing the alkali solution and household waste mixture with a dry mixture of cement and aggregate to form a concrete mixture. The concrete mixture can then be used in the construction of building elements or may in turn be used as an aggregate material in future concrete mixtures. Expensive composting steps are thereby avoided and the household waste is handled in an environmentally secure, yet efficient manner.

This is a continuation application of Ser. No. 10/532600 filed Dec. 7, 2005, which in turn is a nationalization of PCT/IE03/000146 filed Oct. 24, 2003 and published in English.

### INTRODUCTION

This invention relates to a method of using household waste in the production of concrete. Reference is made to the applicant's own co-pending Irish Patent Application Number 2002/0831 and European Patent Application Number 02394102.4 both entitled “A method of using wastewater sludge in the production of concrete”, having the same priority date as the present application, the content and disclosure thereof being incorporated herein by reference.

Nowadays, people are becoming more aware of the need to recycle their refuse in an environmentally friendly manner. Local authorities and other companies that have been entrusted with refuse disposal have begun implementing extensive recycling programmes whereby much of the refuse to be disposed of is separated off and sent to dedicated recycling plants for re-use. Typically, glass, paper and other such products have been separated from the remaining refuse and sent for recycling. Other waste such as household waste and in particular biodegradable household waste is usually subjected to further treatments before being sent to landfill, incineration or dumping at sea. Generally speaking though, these methods of disposal are often relatively expensive and various separate environmental issues arise from each method of disposal.

Another solution suggested for the treatment of biodegradable household waste is composting. The waste is stored for a prolonged period of time, usually over six weeks, and allowed to decompose. The decomposed waste may then be used as compost for agricultural or horticultural purposes. This allows for the waste to be recycled in an environmentally friendly manner. There are, however, problems associated with this known method of recycling biodegradable household waste. The first problem with this method is the noxious smell that is released by the biodegradable household waste as it decomposes. This can be quite overpowering and often leads to complaints and disputes with neighbouring residents. To contain the noxious smell from the decomposing matter, the composting is frequently carried out in negative pressure sheds so that the smell affects the surrounding environment as little as possible. However, these sheds are quite expensive to provide and further increase the cost of recycling the biodegradable household waste. Furthermore the entire process is quite lengthy and time consuming to complete.

It is an object therefore of the present invention to provide a method of recycling household waste and in particular, biodegradable household waste in an environmentally friendly manner that is both simple and inexpensive to implement and that overcomes at least some of the difficulties of the prior art.

### STATEMENTS OF INVENTION

According to the invention, there is provided a method of treating household waste comprising the steps of:
(a) separating any non-biodegradable waste above a predetermined size from the household waste for subsequent disposal;
(b) shredding the remaining household waste in a shredder;
(c) mixing the shredded household waste with an alkali solution to form an alkali and household waste mixture having a pH above 11.5;
(d) separating any remaining metallic waste from the alkali and household waste mixture for subsequent disposal;
(e) separating any wood or plastics material from the alkali and household waste mixture for subsequent disposal;
(f) removing any gases emitted by the alkali and household waste mixture;
(g) subjecting the alkali and household waste mixture to a centrifuge to form sludge cake having a liquid content of between 60% and 95%, and untreated water; and
(h) mixing the sludge cake with a dry mix of aggregate and cement to form a concrete mixture.

This is seen as a particularly efficient method of treating household waste as the non-biodegradable waste is removed gradually from the household waste, leaving the biodegradable waste that was heretofore difficult to dispose of in a safe and cost efficient manner. Extensive composting of the biodegradable waste will not have to be carried out which will therefore negate the need for storing the compost for a significant period of time, as well as having to provide negative pressure sheds and the like to contain the smell emanating from the decomposing biodegradable waste. The waste is neutralised and contained within a concrete mixture in a quick and efficient manner. By creating an alkali and household waste mixture having a pH of greater than or equal to 11.5, the vast majority of any harmful bacteria contained in the biodegradable waste will be eliminated from the household waste, thereby helping to provide a concrete mixture that is both environmentally secure and may be used in public construction projects. Furthermore, any viruses present in the concrete will be killed off and the risk of subsequent leeching from the concrete of harmful materials is much reduced by having the pH of the alkali and household waste mixture above 11.5. By passing the household waste through the above steps sequentially, the household waste may be separated out in a quick and efficient manner, requiring the minimum of human intervention, thereby providing a cost efficient method of treating the household waste.

In another embodiment of the invention, the step of separating any remaining metallic objects from the alkali and household waste mixture for subsequent disposal further comprises passing the alkali and household waste through an eddy magnet. This is seen as a particularly efficient and cost effective way of removing the remaining metallic objects from the household waste. These metallic objects may then be stored separately for onward recycling.

In one embodiment of the invention, the step of separating any wood or plastics material from the alkali and household waste mixture for subsequent disposal comprises passing the alkali and household waste mixture through a floatation tank and skimming the wood and plastics material from the floatation tank. This is seen as particularly efficient as the wood and plastics materials may be removed from the other biodegradable household waste which is the major cause of the undesirable smells, as well as being the source of most diseases, and the wood and plastics which are reasonably innocuous may be passed onwards for recycling.

In a further embodiment of the invention, the further step is carried out of passing the untreated water to a water treatment plant for sanitation and recycling. This water may be used for more useful purposes such as general water supply or in the production of concrete, further down the line.

In another embodiment of the invention, the additional step is carried out of pouring the concrete mixture into plastic containers to prevent inadvertent leaching of contaminants from the concrete mixture. This is seen as a particularly efficient way of preventing any leeching of contaminants from the concrete mixture that may still remain after the household waste has been turned into concrete.

In one embodiment of the invention, the gases removed from the alkali and household waste mixture are passed to a burner for burning. This is a useful way of handling the gases in a clean and efficient manner that is cost effective in its implementation and may even contribute to heating or powering of the place in which the method is being carried out.

In one embodiment of the invention, the step of mixing the shredded household waste with an alkali solution further comprises mixing the shredded household waste with an alkali solution having a pH equal to or above 12.5. Alternatively, the alkali solution could have a pH above 13. Furthermore, the alkali solution could have a pH above 13.5. By having a high pH alkaline solution, a more efficient kill of bacteria in the biodegradable matter is achieved and a concrete that will not present environmental danger will be provided.

In a further embodiment of the invention, the sludge cake is added in sufficient quantities so that the sludge cake forms between 5% and 50% by weight of the concrete mixture. This is a useful and efficient way to dispose of the sludge cake, while still maintaining the strength and durability characteristics of concrete that is acceptable in the use of building materials. Alternatively, the sludge cake may be added in sufficient quantities so that the sludge cake forms between 10% and 40% by weight of the concrete mixture. Alternatively, the sludge cake could be added in sufficient quantities so that it forms between 15% and 30% by weight of the concrete mixture. It is important that a concrete of sufficient durability and strength is produced.

In another embodiment of the invention, the aggregate and cement are mixed together in a separate container prior to mixing with the sludge cake. By mixing the aggregate and cement in a separate container prior to mixing with the sludge cake, the alkali may work on the harmful bacteria contained in the sludge cake, without having to act on other substances at the same time. This will enhance the usefulness and effectiveness of the alkali solution in killing bacteria in the sludge cake.

In one embodiment of the invention, the step of mixing the shredded household waste with an alkali solution further comprises mixing the shredded household waste with a concrete hardener. It has been found that a concrete hardener may act as an alkaline solution and kill bacteria present in the biodegradable household waste. Furthermore, the concrete hardener will help to harden the concrete mixture in due course and will not have a detrimental effect on the quality of the concrete produced.

In a further embodiment of the invention, the additional step is carried out of adding a bonding agent to the concrete mix. It is envisaged that the bonding agent may have a pH in the region of 8 to 11. The bonding agent used may be carboxylated styrene butadlene alkali. By adding a bonding agent to the concrete mix, there will be provided better adhesion of the component particles in the concrete, also improving the pH properties of the concrete.

In another embodiment of the invention, the aggregate comprises one or more of grey wacke stone, sand, sandstone, gravel, limestone, crushed shale, crushed seashells, pencil, kiln dried sand, grit, pulverised fuel ash, slag from steelworks, and recycled crushed concrete.

In one embodiment of the invention, the method further comprises the additional step of allowing the concrete mixture to set and after a predetermined length of time, crushing the concrete mixture for subsequent re-use as an aggregate in the method. This is seen as a useful way of recycling more biodegradable household waste. It is also very efficient in reducing the costs of the production of the concrete mix, as previously recycled biodegradable household waste will have been used in its production.

In one embodiment of the invention, the method further comprises the step of adding water to the concrete mixture, on addition of the sludge cake to the cement and aggregate mixture. This will ensure that a good mixture of concrete will be formed that is both strong and durable.

In a further embodiment of the invention, the method further comprises the step of adding a detergent to the concrete mixture prior to curing. By adding a further detergent to the concrete mixture, the bacteria kill will be enhanced, thereby providing a concrete that is more environmentally secure and will not leech contaminants into the soil after curing.

In another embodiment of the invention, the sludge cake, cement and aggregate are mixed in a ratio of 1:1:6 by weight to form the concrete mixture. This is seen as a useful ratio of sludge cake, cement and aggregate to use in the concrete mixture, that will provide a concrete that is both strong, durable and can be used in varied applications.

In a further embodiment of the invention, the method further comprises the step of milling the household waste prior to separating any wood or plastics material therefrom. This will further enhance the separation of the wood and plastics material from the remaining biodegradable household waste, as the household waste will be ground into a fine granular material that will separate quicker and more evenly in a floatation tank.

In one embodiment of the invention, the step of mixing the sludge cake with the cement and aggregate to form a concrete mixture is performed in the mixing drum of a concrete mixing truck. This is seen as a particularly useful way of mixing the sludge cake with the cement and aggregate, as additional drums would not have to be provided and the aggregate and cement can be premixed before the introduction of the sludge cake. The concrete mixture may then be brought to a desired destination before being poured and setting on site.

In a further embodiment of the invention, the sludge cake has a solids content of between 10 and 40%. Ideally, the solids content will be between 10 and 25%. In this way, the household waste will be able to provide sufficient water to produce concrete and additional water will not be required in its production.

In one embodiment of the invention there is provided a method of using household waste in the production of concrete comprising the steps of mixing cement, aggregate and household waste together to form a concrete mix, characterized in that the method further comprises the initial steps of:
(a) shredding the household waste to a predetermined particle size;
(b) mixing an alkali solution with the shredded household waste to form an alkali and household waste mixture having a pH equal to or greater than 11.5, prior to mixing with the cement and the aggregate.

This is seen as a particularly useful method of using household waste in the production of concrete that is both efficient and cost effective. By using this method there will be no need for expensive incineration steps to be carried out as once an alkali and household waste mixture having a pH equal to or greater than 11.5 is produced the majority of the harmful bacteria contained in the household waste will be eliminated by the strong reaction. The remainder of the harmful bacteria, if any, will be neutralized by trapping the bacteria in the concrete product. The concrete product produced will be suitable for most building applications and will satisfy even the most stringent health and safety legislation. The method provides a very simple and inexpensive alternative to methods in which incineration, extensive pre-treatment or composting steps are required that slow down the process as well as adding to the overall cost of the process.

In another embodiment of the invention there is provided a method of using household waste in the production of concrete in which the alkali solution is added to the shredded household waste so that the alkali and household waste mixture has a liquid content by weight of between 60% and 90%. This is seen as beneficial as by having an alkali and household waste mixture with such a liquid content, further water will not have to be added to the cement and aggregate when the concrete is being produced. Furthermore, the alkali solution will be very effective in such an aqueous solution in breaking down the bacteria present in the household waste quickly and effectively.

In a further embodiment of the invention there is provided a method of using household waste in the production of concrete in which the alkali solution is added to the shredded household waste so that the alkali and household waste mixture has a liquid content by weight of between 75% and 90%. This is seen as particularly beneficial as a very high percentage of all bacteria contained in the household waste will be eliminated almost instantly and there will be sufficient liquid content for the subsequent production of concrete.

In one embodiment of the invention there is provided a method of using household waste in the production of concrete in which the method further comprises the steps of:
(c) passing the alkali and household waste mixture through a centrifuge to separate the alkali and household waste mixture into sludge cake having a liquid content by weight of between 65% and 90%, and untreated wastewater;
(d) drawing off the untreated wastewater and leaving only the sludge cake; and
(e) mixing the sludge cake with the cement and aggregate mixture.

This is seen as a particularly useful way of eliminating a significant proportion of the wastewater from the alkali and household waste mixture that will not be required in the subsequent concrete mixing step. The wastewater is at this stage a reasonably safe and may be disposed of by alternative measures.

In another embodiment of the invention there is provided a method of using household waste in the production of concrete in which the alkali and household waste mixture are passed through a centrifuge until the sludge cake has a liquid content of between 75% and 85%. This is seen as a sufficient amount of liquid to aid in the subsequent concrete making step yet not requiring the addition of any further water in the concrete mixing step. At the same time, any unnecessary wastewater is drawn off the sludge cake.

In a further embodiment of the invention there is provided a method of using household waste in the production of concrete in which the household waste is shredded to provide a shredded household waste having an average particle size of between 1 mm and 10 mm. Preferably the household waste is shredded to provide a shredded household waste having an average particle size of between 3 mm and 8 mm. This is seen as a useful particle size as it is easier for the alkali solution to break down and will more readily mix with the alkali solution. Furthermore, this particle size will also form a robust concrete mixture that will form durable concrete that may be used in a variety of applications.

In one embodiment of the invention there is provided a method of using household waste in the production of concrete in which the alkali solution added to the household waste is a concrete hardener. This will further enhance the effectiveness and usefulness of the concrete produced by the method as the concrete will harden faster and lengthy setting times will not be required while at the same time the effectiveness of the bacterial kill will not be diminished.

In another embodiment of the invention there is provided a method of using household waste in the production of concrete in which the method further comprises the step of adding a bonding agent to the concrete mix.

In a further embodiment of the invention there is provided method of using household waste in the production of concrete in which the step of adding an alkali solution to the shredded household waste further comprises the step of adding an alkali solution having a pH equal to or above 12.5. This will ensure that a high initial bacterial kill is achieved when the alkali solution is added to the household waste. The strong alkali will be effective very shortly after it has been introduced.

In one embodiment of the invention there is provided a method of using household waste in the production of concrete in which the alkali and household waste mixture comprises between 5 and 50% by weight of the concrete mixture. Alternatively, the alkali and household waste mixture comprises between 10% and 40% by weight of the concrete mixture. Preferably, the alkali and household waste mixture comprises between 15% and 30% by weight of the concrete mixture. This will provide a strong and durable concrete that may be used for numerous applications while at the same time providing a concrete that will contain a high amount of household waste therein that is disposed of simply and efficiently.

In another embodiment of the invention there is provided a method of using household waste in the production of concrete in which the alkali and household waste mixture, cement and aggregate are mixed in the ratio 1:1:6 by weight to form the concrete mixture. This will further provide a strong concrete that aids the disposal of a high proportion of household waste.

### DETAILED DESCRIPTION OF THE INVENTION

The invention will now be more clearly understood from the following description of some embodiments thereof, given by way of example only, with reference to the accompanying drawings, in which:

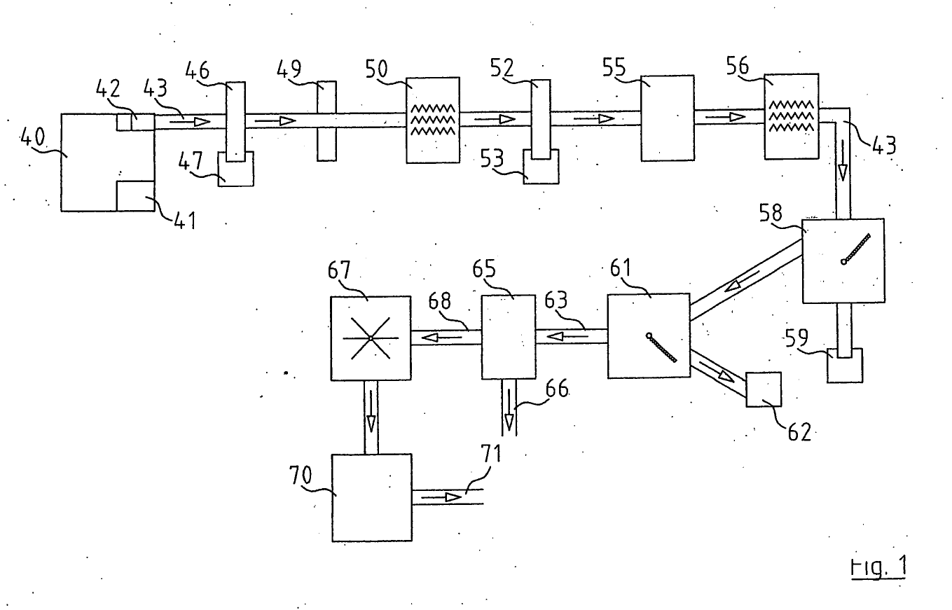

FIG. 1 is a diagrammatic view of a typical plant layout suitable for performing the process according to the invention,

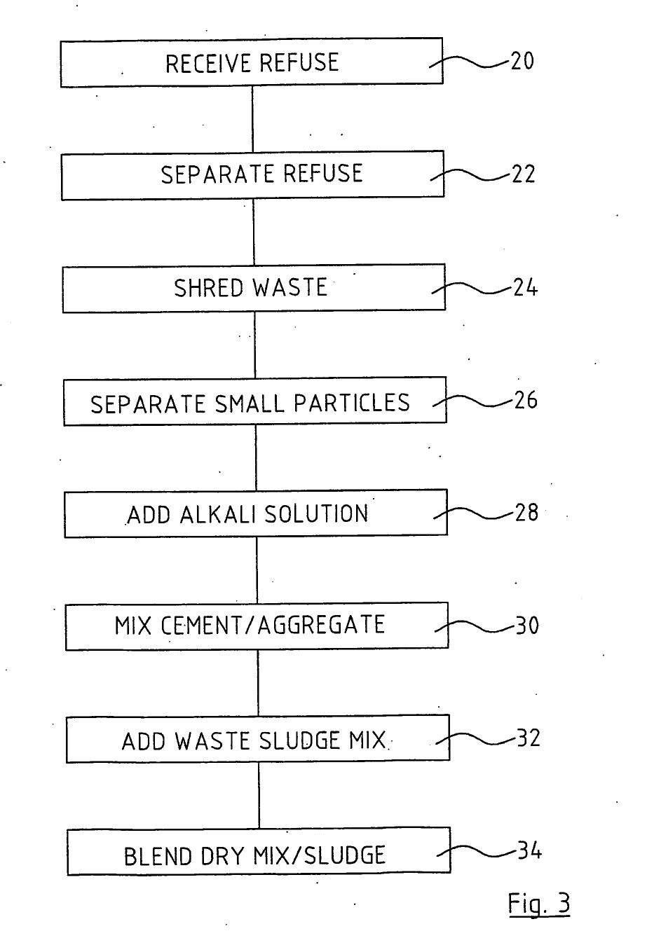

FIG. 2 is a diagrammatic illustration of one form of suitable apparatus that may be used for carrying out the invention; and

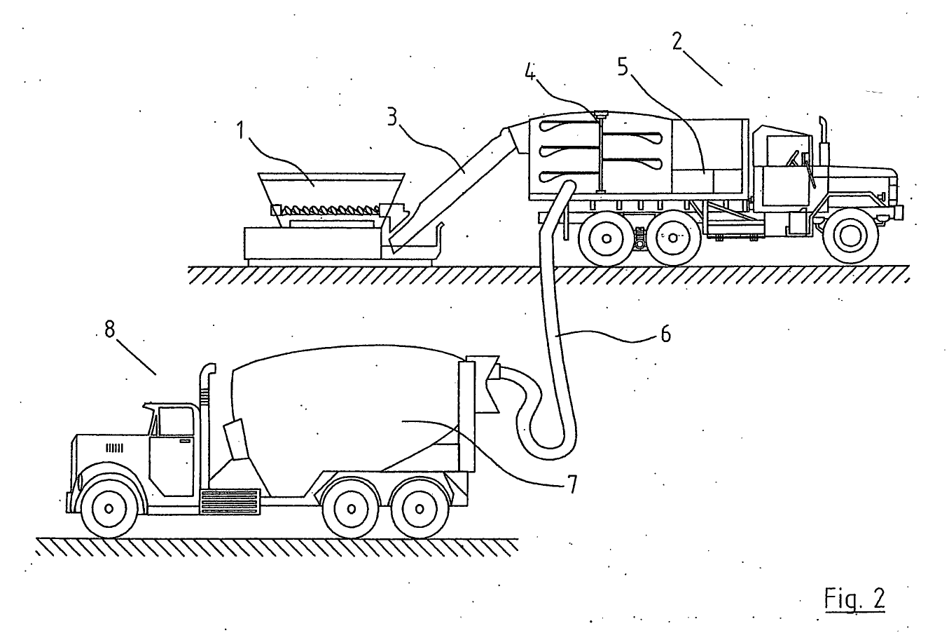

FIG. 3 is a block diagram of the process of recycling household waste according to the invention.

Referring to the drawings, and initially to FIG. 1 thereof, there is shown a diagram of a typical plant layout suitable for performing the method according to the invention. Refuse is taken in, in rubbish intake area 40. The refuse is stored in storage area 41 until ready for processing. When desired, the refuse is passed to hopper/bag ripper 42 and thereafter placed on conveyor belt 43. An over belt magnet 46 extracts any large pieces of metal and deposits them to metal skip 47. Further undesirable pieces of refuse are manually separated at picking station 49. The refuse then proceeds along the conveyor belt to shredder 50 where the refuse is shredded into smaller particles. The shredded refuse continues along conveyor to an over belt Eddy magnet 52 which collects further metal objects such as aluminium cans and deposits them into skip 53.

The remaining refuse passes through finger screen blower and sucker 55 and onwards to a high speed mill/shredder 56. Once this is complete the shredded material is passed to the floatation tank 58 where a predetermined quantity of alkali solution is added to the shredded household waste to form an alkali and household waste mixture having a pH above 11.5. Any plastics and wood present in the alkali and household waste mixture are then skimmed from the mixture in the floatation tank 58. The plastics and wood collected are passed to a dedicated skip 59. The remaining shredded refuse continues to sealed gas extractor tank, with skimmer and agitator, 61. Gases from the sealed gas extractor tank 61 are fed off to gas fire burner generator 62 for burning and the treated alkali and household waste mixture is fed through pipe 63 to centrifuge 65 to form sludge cake having a liquid content of between 60% and 95% and untreated wastewater. The untreated wastewater from the centrifuge step is passed to a water treatment plant along pipe 66 with the remaining sludge cake passed to a paddle mixer 67 along pipeline 68. Additives may be added to the sludge cake in the paddle mixer 67 before being sent to concrete plant mixer 70 where the sludge cake that had additives mixed thereto such as a concrete hardener or bonding agent are mixed with a dry mix of concrete and aggregate. The alkali solution itself has a pH of equal to or above 12.5. The dry mix of concrete and aggregate has already been thoroughly mixed at that stage prior to the addition of the sludge cake. Finally, the concrete mix is passed to a mould shed (not shown) along pipeline 71.

Referring to FIG. 2, there is shown a diagrammatic illustration of one form of suitable apparatus for carrying out the method. Shredded household waste is fed from a container 1 to a mixing truck 2 by way of conveyor 3. A conveyor 3 has load cells (not shown) connected thereto to carefully monitor the amount of household waste being delivered to the mixing truck 2. The household waste is placed in a paddle mixer 4 of the mixing truck 2 wherein it is mixed with an alkali solution to form an alkali and household waste mixture having a pH above 11.5. Once the household waste and alkali solution have been mixed sufficiently, a pump 5 on mixing truck 2 is actuated to pump the household waste and alkali mixture through a flexible hosepipe 6 to a mixing drum 7 of a nearby concrete mixing truck 8. The mixing drum 7 has already contained therein, a thoroughly blended mixture of cement and aggregate. Once the alkali and household waste mixture has been added to the mixing drum 7 containing the aggregate and cement, the mixing drum 7 is rotated, thereby blending the materials contained therein to form a concrete mixture. Additional water may be added to the aggregate, cement and alkali and household waste mixture, if necessary.

One example of a concrete mixture made in accordance with the present invention will now be given:

### EXAMPLE 1

One ton of household waste is shredded in a shredder so that the average particle size of the household waste is between 1 and 10 mm. The shredded household waste is then mixed with 5 tons of alkaline solution to form an alkaline and household waste mixture having a pH equal to or greater than 11.5. At the same time, in a separate container, 6 tons of cement are mixed with 36 tons of aggregate. In this case the aggregate is limestone. The cement and the aggregate are thoroughly mixed together to form a dry mix before the 6 tons of alkali and household waste mixture are added to the cement and aggregate to form the concrete mixture. The concrete mixture is then left to set over a period of time.

Referring now to FIG. 3 of the drawings, there is shown a block diagram of the process of recycling household waste according to the invention. In step 20, refuse is received at the refuse disposal depot. In step 22, this refuse is separated by hand or other means into various different types of refuse, including glass, plastics, paper and other biodegradable matter. In step 24, the biodegradable matter is placed in a shredder where the matter is broken up into smaller pieces. In step 26, a further separation step may be carried out to remove any remaining small sized non-biodegradable materials from the household waste. In step 28, an alkali solution is added to the shredded biodegradable waste material to further sanitise the biodegradable waste and form an alkali and household waste mixture.

In step 30, in a separate mixing tank, cement and aggregate are mixed together thoroughly to form a dry mix. The alkali and household waste mixture is introduced into the separate mixing tank with the dry mix, in step 32, and they are blended together to form a concrete mixture in step 34. The concrete is then ready to be poured and made into concrete products or other similar articles.

The relative amounts of household waste, cement and aggregate are determined, depending on the strength and curing time requirements of the individual producing the concrete. The alkali solution blended with the household waste can be a concrete hardener such as that sold under the brand name Sika [Registered Trade Mark (RTM)]. The alkali will further act as a hardener assisting in the curing time of the concrete mix once the alkali and household waste mixture and the dry mix have been blended together.

In addition to the alkali solution, a bonding agent such as those sold under the Registered Trade Marks EVOSTICK, RONAFIX or POLYVINYL ACETATE is further added to the household waste sludge mixture to improve the pH value of the concrete to be produced, whilst also improving the bonding properties of each of the main components in the concrete. The bonding agent typically will have a pH in the region of 8 to 11. This concrete mix may then be used to construct road side barriers, concrete verges, and the like. Indeed, the concrete produced may be crushed and used as an aggregate for further concrete, made in accordance with this method.

A liquid detergent such as those produced by JEYES (RTM), DETTOL (RTM) or FLASH (RTM) may be added to the unsolidified concrete mixture to further eliminate any residual bacteria present in the wastewater sludge. The concrete may then be poured into a heavy duty plastic container and sealed therein to avoid any risk of contamination to the environment by leaching of the concrete once it has been exposed to the elements.

It will be understood that the entire process could be carried out in one large shed or three smaller sheds comprising an intake area, a sorting and shredding area and a concreting plant and manufacturing area linked by pipes or conveyors. The shed(s) could be provided with negative pressure and/or extractor units if necessary. It is envisaged that the mixing of the cement and aggregate could also be performed in a standard concrete mixing truck or in such similar device. The alkali and household waste mixture could be added to the dry mix in the concrete mixing truck, once any additional hardening agents or bonding agents have been thoroughly mixed in with the alkali and household waste mixture. Reinforcing materials such as glass, fibre or steel can also be added as part of the aggregate, further strengthening the concrete produced. As an alternative to a heavy duty plastic container, a fibreglass coating or plastic coating may be applied to concrete produced in accordance with the method to add further protection and additional strength to the concrete.

It is envisaged that the sludge cake or alkali and household waste mixture is added in sufficient quantities so that the sludge cake or alkali and household waste mixture forms between 5% and 50% of the concrete mixture. Alternatively, the sludge cake or alkali and household waste mixture forms between 10% and 40% of the concrete mixture or indeed between 20% and 30% of the concrete mixture.

Once the concrete mixture has been allowed to set and harden over a period of time, the concrete produced by this method could be crushed and reused as an aggregate material thereby further using more of the biodegradable household waste in the final concrete mixture produced and safely disposing of higher levels of biodegradable household waste.

In this specification, the term “hardening agent” has been used to define a substance that will reduce the time necessary for the concrete mixture to set. The concrete bonding agent is used to describe a substance that is used to enhance the cohesion of the individual ingredients, once mixed. Potassium carbonate or aluminium silicate could act as hardening components. The alkali solution used could be an alkali solution of potassium hydroxide or alternatively sodium hydroxide, calcium hydroxide or barium hydroxide or other similar substance. In the description the alkali solution is said to have a pH of equal to or above 12.5. It is envisaged that the alkali solution could have a pH of equal to or above 13 or even 13.5. What is important is that the pH level is sufficient to provide an adequate kill of bacteria in a quick and efficient manner.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is in no way limited to the embodiments hereinbefore described, but may be varied in both construction and detail.

1. A method of treating household waste comprising the steps of:
(a) separating any non-biodegradable waste above a predetermined size from the household waste for subsequent disposal;
(b) shredding the remaining household waste in a shredder;
(c) mixing the shredded household waste with an alkali solution to form an alkali and household waste mixture having a pH above 11.5;
(d) separating any remaining metallic waste from the alkali and household waste mixture for subsequent disposal;
(e) separating any wood or plastics material from the alkali and household waste mixture for subsequent disposal;
(f) removing any gases emitted by the alkali and household waste mixture;
(g) subjecting the alkali and household waste mixture to a centrifuge to form sludge cake having a liquid content of between 60% and 95%, and untreated water; and
(h) mixing the sludge cake with a dry mix of aggregate and cement to form a concrete mixture.

2. A method of using household waste in the production of concrete comprising the steps of mixing cement, aggregate and household waste together to form a concrete mix, characterized in that the method further comprises the initial steps of:
(a) shredding the household waste to a predetermined particle size;
(b) mixing an alkali solution with the shredded household waste to form an alkali and household waste mixture having a pH equal to or greater than 11.5, prior to mixing with the cement and the aggregate.
